(19) United States
(12) Patent Application Publication
(10) Pub. No.: US 2026/0024093 A1
(43) Pub. Date: Jan. 22, 2026

(54) SYSTEMS AND METHODS TO STOP UNDESIRED ACCOUNT SUBSCRIPTIONS

(71) Applicant: INMARKET MEDIA, LLC, Austin, TX (US)

(72) Inventors: Todd DIPAOLA, Austin, TX (US); Surojit NIYOGI, Austin, TX (US); Sohrab PIRAYESH, Redondo Beach, CA (US); Viacheslav AGAFUROV, Marina Del Rey, CA (US); Kazuya FUJITA, Bakersfield, CA (US); Wei TANG, Seattle, WA (US)

(21) Appl. No.: 19/270,881

(22) Filed: Jul. 16, 2025

Related U.S. Application Data
(60) Provisional application No. 63/671,816, filed on Jul. 16, 2024.

(51) Int. Cl. G06Q 20/40; G06Q 20/22; G06Q 20/38

(52) U.S. Cl. CPC G06Q 20/407; G06Q 20/227; G06Q 20/3821; G06Q 20/4014

(57) ABSTRACT

Some implementations address the difficulties and inefficiencies associated with finding and canceling user accounts. Some implementations relate to systems and methods that provide an automated, user-friendly solution to manage and cancel subscriptions, memberships, and other ongoing payment accounts. The systems and methods may leverage computer algorithms, machine-learning models, user preferences, payment systems, and automated processes to streamline the identification and cancellation of undesired accounts, making a difficult-to-complete process much faster and easier for users.

### CROSS-REFERENCE TO RELATED APPLICATIONS

This application claims the benefit of U.S. Provisional Application Ser. No. 63/671,816 filed Jul. 16, 2024, which is incorporated herein in its entirety.

### FIELD OF THE INVENTION

The present invention relates to systems and methods for managing and canceling user accounts, particularly those associated with ongoing payments such as subscriptions and memberships.

### BACKGROUND OF THE INVENTION

It can be difficult and time-consuming to manage user accounts that are associated with ongoing payments, such as subscriptions and memberships. Users may not be aware of their accounts and the accounts may be difficult to cancel, often leaving undesired accounts active for much longer and costing more than they would if users were aware of their accounts and able to easily cancel accounts. Canceling undesired accounts is often difficult and, indeed, may have been made intentionally difficult or cumbersome by certain vendors who want to retain the ongoing payments as long as possible. Some vendors utilize deceptive and/or cumbersome user interfaces and other types of dark patterns to make it difficult to cancel via web pages. Some vendors require that the user perform certain cumbersome processes to cancel an account, e.g., hunting for where to cancel, requiring text chatting with a representative, requiring calling a representative at a customer service center with limited hours and long hold times, requiring submitting a signed cancellation form, requiring visiting a physical location associated with the vendor, etc. Some vendors' systems or representatives divert the user from canceling, e.g., with special offers that need to be declined or protracted discussions of reasons for cancellation.

### SUMMARY OF THE INVENTION

Some implementations disclosed herein address the difficulties and inefficiencies associated with finding and canceling user accounts. Some implementations relate to systems and methods that provide an automated, user-friendly solution to manage and cancel subscriptions, memberships, and other ongoing payment accounts. The systems and methods may leverage computer algorithms, user preferences, payment systems, and automated processes to streamline the identification and cancellation of undesired accounts, making a difficult to complete process much faster and easier for users.

In one exemplary implementation, a processor executes instructions stored in a non-transitory computer-readable medium to perform a method. The method involves presenting a user interface identifying multiple user accounts for multiple vendors, each of the user accounts associated with a recurring automatic payment to the vendor until cancelled. The user accounts may be identified via an automatic account identification process, for example, a process that examines a user's checking, credit, or other financial accounts for recurrent payments. Accounts that require contractual changes for cancellation may be flagged. The user may provide login credentials for one or more user accounts of the multiple user accounts or existing sessions may be identified (e.g., by identifying open apps on a mobile device or open webpages corresponding to a respective user account).

The method may further involve receiving input to take automatic actions to cancel one or more user accounts of the multiple user accounts. For example, a user may select a subset or all of the user accounts and initiate a user interface command to initiate automatic cancellation of the accounts. The method may further involve determining a cancellation technique for each of the one or more user accounts. For example, such a determination may be based on a repository with account vendor-specific info. Such a repository may be maintained (e.g., by a cancellation service provider) by monitoring and tracking landscape of paths to billing info pages on account vendor websites.

The method may further involve, in accordance with the cancellation technique for each of the one or more user accounts: accessing electronic account services for the one or more user accounts; and/or modifying payment information for the one or more user accounts via the electronic account services to change a payment method to a credit or debit card account having a balance or limit insufficient to cover the recurring automatic payment associated with the respective user account. Accessing the electronic account services, for example, may involve using login credentials to create new webpage/app sessions or accessing an existing session(s) on an already open webpage or app. Modifying the payment information may involve specifying a credit or debit card account with a $0, $1, $2, $5, etc. balance or limit. The method may involve changing contact info associated with the account (e.g., changing user e-mail, phone, etc.). Doing so may enable vendor inquiries to be addressed automatically. A repository of prepaid debit cards, etc. may be maintained for ready use so that cancellation processes may begin immediately upon receiving the user's instruction to cancel the accounts. One or more prepaid debit cards may be automatically provisioned to use specifically for cancellation. Such cards may be maintained in a repository for ready use in cancellation processes. The user interface may show the user live or recorded the changes made to the accounts as the automatic cancellation processes are performed. Once modified, the method may further involve providing a notification via the user interface that the one more user accounts have been modified for cancellation purposes.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE FIGURES

These and other features, implementations, and advantages of the present disclosure are better understood when the following Detailed Description is read with reference to the accompanying drawings.

FIG. 1 illustrates an exemplary computing environment according to some implementations disclosed herein.

FIG. 2 is a flow chart illustrating an exemplary method for addressing undesired user account subscriptions according to some implementations disclosed herein.

FIG. 3 is a flow chart illustrating another exemplary method for addressing undesired user account subscriptions according to some implementations disclosed herein.

FIG. 4 is a flow chart illustrating another exemplary method for addressing undesired user account subscriptions according to some implementations disclosed herein.

FIG. 5 is a flow chart illustrating another exemplary method for addressing undesired user account subscriptions according to some implementations disclosed herein.

FIG. 6 is a flow chart illustrating another exemplary method for addressing undesired user account subscriptions according to some implementations disclosed herein.

FIG. 7 is a flow chart illustrating another exemplary method for addressing undesired user account subscriptions according to some implementations disclosed herein.

FIG. 8 is a flow chart illustrating another exemplary method for addressing undesired user account subscriptions according to some implementations disclosed herein.

FIG. 9 is a flow chart illustrating another exemplary method for addressing undesired user account subscriptions according to some implementations disclosed herein.

FIG. 10 is a flow chart illustrating another exemplary method for addressing undesired user account subscriptions according to some implementations disclosed herein.

FIG. 11 is a block diagram depicting an example hardware implementation.

### DETAILED DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

Some implementations provide an automated solution for managing and canceling user accounts associated with ongoing payments. This may involve systems and methods that provide a usage analysis module and an automated cancellation execution module. By computer algorithms, machine-learning models, and/or via other automated processes, the system streamlines the identification and cancellation of undesired accounts, overcoming deliberately deceptive and cumbersome cancellation processes employed by some vendors. The systems and methods may enable efficient and secure account management and cancellation for users.

Some implementations provide systems and methods that enable users to find or manage their accounts associated with ongoing payments based on examining each user's checking, credit, and other financial accounts used for payment. A user interface may be presented to the user (e.g., via a website or app) that enables to user to quickly and easily manage the cancellation of their user accounts. The user interface may identify the user's accounts, e.g., in an interactive list, and provide actions that are available for individual accounts or selected accounts. The user interface may categorize accounts based on the types of actions that may be taken and/or required to cancel the respective accounts. The user interface may indicate which accounts require contractual changes for cancellation, which accounts may be cancelled by changing payment information, which accounts may be cancelled automatically, for example, via a bot that navigates through an electronic account services for the one or more user accounts (e.g., the account vendor's webpage or app interface), etc. The user interface may list and enable users to easily cancel undesired accounts, e.g., by providing user login credentials and/or clicking/selecting a single user interface control/button to cancel selected accounts. The system may automatically perform the actions necessary to cancel the accounts. In some cases, user action is additionally desired or required. For example, a given account may require an e-mail from a user to initiate and/or confirm cancellation. The system may automatically draft such an e-mail for the user to send to the vendor to perform the required cancellation initiation and/or confirmation.

Some implementations involve the system automatically determining an appropriate cancellation technique to cancel a given account. This may be based on a repository with account vendor-specific info. Such a repository may be maintained by monitoring and tracking the landscape of paths to cancellation, billing information, or other access points on each vendor's websites and/or app. The system may monitor for issues/breach and/or revise or repair account-vendor specific information, for example, based on tracking when vendors change their websites/apps, and automatically updating the scripts that access those websites to cancel accounts and/or change user information. The system may use such information to automatic cancellation directly and/or to change payment information to affect cancellation indirectly. The system may use verified paths to cancelation and/or user information change, to avoid common intentional pitfalls in the cancellation process and avoid undesired prolongation of ongoing subscriptions and account payments.

Some implementations enable users to cancel some or all of their undesired accounts without the user needing to navigate through, understand, or otherwise use cumbersome account vendor cancellation UIs or processes or having to contact customer service representatives.

Some implementations effectively cancel accounts by eliminating vendor's ability to charge the user to continue the account. For example, this may be achieved by creating and designating a cancellation card (e.g., low limit, expiring, voided) to replace user's payment info (using user's credentials to access and change the account info). When (or if) the vendor attempts to charge the user, the charge will not go through or will be insufficient and the vendor will cancel the account. In some implementations, the system further changes the user's contact information (e.g., e-mail and phone number) so that vendor inquiries can be addressed automatically.

Some implementations facilitate replacement of user payment information with insufficient payment accounts in an efficient and prompt manner. Such methods may involve automatically generating cards/accounts (e.g., prepaid cards) that are ready and waiting to be used for instant cancelation when the user presses the option/button to cancel an account.

Some implementations provide an interactive account cancellation process that performs some cancellation processes automatically and provides guidance to perform other cancellation steps manually. The guidance may be provided based on a machine learning model that (1) uses a machine learning model or algorithm to interpret image and/or text data to understand the state of a session involving a manual or automatic interaction with a vendor's website/app (i.e., where is the user in the vendor's website), (2) uses a machine learning model or algorithm to determine an appropriate next step for cancellation of the user account based on the understanding of the state of the session, (3) uses a machine learning model or algorithm to perform the next step, and/or (4) uses a machine learning model or algorithm (e.g., an LLM) to configure instructions for the user to perform the next step. A guided, interactive cancellation process may be performed. In some implementations, automated steps are captured or recorded for user viewing or records. The user may be enabled to view screen shots as an automated script is executed to perform automatic interactions with a vendor's website/app. The user may view the automated actions taken to cancels their account and/or provide new payment information. In some implementations, a user is enabled to watch as an automated process navigates through (or is instructed to themselves navigate through) a vendor's cumbersome menu architecture/dark patterns to access the vendor's cancellation page, user information page, etc. Such navigation may be based on a repository of regularly updated information about vendor websites/apps.

In some implementations, the system identifies whether users are currently using ACH or Credit Card as their payment method to maintain current pricing in situations where ACH may provide a discount to the user from the vendor.

Vendors may block IP addresses that appear like “VPNs” for example to avoid large numbers of sessions from users originating from individual IP addresses. Some implementations circulate through the IP addresses used to ensure access to the vendor's website/app and provide the capability to switch payment methods server-side.

In some implementations, the system provides multiple cancellation methods depending on the identified membership type.

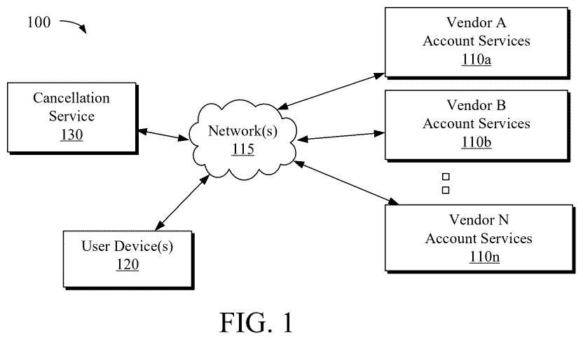

FIG. 1 illustrates an exemplary computing environment 100 in which undesired user account subscriptions may be addressed. In this example, a user has user accounts with a plurality of vendors who provide access to user account information via vendor account services 110a-110b. For example, the user may use user device(s) 120 to access user account information via vendor account services 110a-110b via network 115. For example, the user may access vendor's website and/or app by providing login credentials to initiate a session in which user account information may be viewed and/or edited. The user may also use user device(s) 120 to access cancellation service 130 to address undesired account subscriptions as described herein.

In some implementations, the cancellation service 130 automatically enable users to find or manage all their accounts associated with ongoing payments. People are often busy and unaware of the many accounts that they have (e.g., for streaming services, gym memberships, home security memberships, wearable device memberships, etc.). People often do not have the full picture of all the accounts that they have that are currently active. In some implementations, the cancellation service 130 identifies these accounts and associated payments, and provide a user interface (e.g., by sending information to user device(s) 120) that provides a clear, overall picture of the user's accounts. In some implementations, the cancellation service 130 identifies user accounts based on examining the user's checking, credit, and other financial accounts used for payment. Some implementations automatically determine whether an account is associated with a contractual obligation (e.g., a mortgage account, etc.) and distinguish such accounts in the user interface provided to the user. The user interface may indicate that such accounts require contractual changes for cancellation. The system may identify accounts that are not associated with ongoing contractual obligations (and thus are eligible for automatic and immediate cancellation).

In some implementations, the cancellation service 130 will review multiple accounts of the same person, and in other implementations, multiple authorized accounts will be reviewed together, such as members of the same household or same family, to find duplicate accounts and/or show the entirety of all accounts to all participating members.

In some implementations, the cancellation service 130 enables the user to cancel undesired accounts that are not useful anymore, such as not being used or duplicative. For example, the cancellation service 130 may provide a user interface that lists all of the user's accounts and enable the user to select ones for canceling. A user may be enabled to provide a simple user interface command, e.g., providing user login credentials and clicking a single button to cancel selected accounts, and the cancellation service 130 may automatically perform the actions necessary to cancel those accounts. The user interface may provide feedback to the user regarding the cancellation actions taken and/or results of the cancellations, e.g., confirmations, etc.

The cancellation service 130 may determine an appropriate cancellation technique to cancel a given account. Different accounts may require different cancellation techniques. The cancellation service 130 may keep a vendor repository that identifies cancellation techniques necessary to cancel accounts with particular users. It may identify preferred cancellation techniques for canceling accounts with particular vendors.

Some implementations provide a seamless method for users to effortlessly cancel accounts. Some implementations enable a user to cancel accounts without the user needing to deal with the difficulties of account vendor cancellation user interfaces and other time-consuming and cumbersome processes. Some implementations enable a user to cancel accounts without the user needing to interface with vendors' customer service representatives. Some might be via the website, others might be via emails or automated AI flows that simulate a user performing the cancellation themselves, e.g., with a video recording of the overall process, and others might be via other mechanisms.

Some implementations stop undesired accounts by eliminating the vendor's ability to charge the user via the creation and implementation of a cancellation card. Cancellations cards may be created in advance or created on-demand. A “cancellation card” is payment type with an account that the vendor accepts to replace the user's payment information, however the vendor ultimately cannot charge payments to it. In some implementations, the cancellation card can be a very low limit charge card with a tiny (e.g. $1) balance, a card that has sufficient funds which can be reduced later on, or a card that expires soon after authorization, so the payment method is not able to be successfully charged. The cancellation card may be used as new payment information for an undesired account. The cancellation card then blocks the vendor's ability to charge the user again.

The cancellation card passes vendor authorization, yet ultimately the vendor payment is refused when the undesired account attempts to charge a payment. This may be achieved through different implementations. The cancellation card may expire or be voided before actually being charged. The total limit of the card may be too low (e.g. $1) to approve the expense. In one example, a cancellation card is provided initially with a balance sufficient to satisfy the vendor's preauthorization validation, and then reduced before being actual charged. Some implementations transfer money out of an account (e.g., a debit or gift card account) so that it cannot be charged while others reduce the spending limit. Some implementations put a token amount of money on a cancellation card, (e.g., $1), replacing a user's current payment information with that cancellation card, then reduce the cancellation card's spending limit or withdraw money such that its allowable balance is too low (e.g. $1 or less) to allow any transaction to complete. The system may enter such a cancellation card number as a new payment information with the vendor. Some implementations will delete the users' previous payment information so it is not charged as a fallback when the vendor encounters a failed payment on the cancellation card. Future charges will be attempted to the cancellation card and no longer to the user. Future charges on the cancellation card will fail processing and the user will cease to pay for the undesired account. The account will lapse and terminate based on the detected non-payment.

Some implementations may contact the vendor on the user's behalf to request the account be canceled. In this method, the user's account information may be provided by the user as part of an electronic or mailed request to the vendors without the user needing to draft the request themselves. In some implementations, the e-mail would be pre-populated and the user would only need to review and click send for an email to be sent.

Some implementations provide an automated cancellation process with minimal user effort (e.g., the user provides login credentials or account information) through the user interface without interacting with a vendor themselves. Different techniques may be selected for different vendors, (e.g., canceling via a cancellation card for some vendors while canceling by website navigation to cancel for other vendors). In some implementations the cancellation service 130 uses the login credentials to access the correct parts of the website to cancel the account. In other implementations, the cancellation service 130 uses a cancellation card as described above. In still other implementations, the cancellation service 130 drafts and sends written communication via email, US postal mail, fax, or other means to request a cancellation. Some implementations provide a cancellation service 130 that logs in (e.g., temporarily) into the website of the vendor by passing through user-supplied login credentials (e.g., username and password).

Some implementations use a cancellation card with a token amount of money that can be saved to a phone wallet or other personal digital device. This cancellation card could then be used by the user if, for instance, presence in the vendor's physical location is required.

Some implementations address potential payment information verification techniques. For example, a payment information verification technique may verify that the user's address/zip code identified in the account matches the address/zip code identified for the user's credit card. This may be addressed by generating a cancellation card with the correct address/zip code info and/or changing the user's account address/zip code information to match the cancellation card.

Some implementations are integrated as part of a user's existing financial accounts (such as a bank, credit card, or app) and provide an added user benefit to an account with a particular financial company. In this manner, undesired accounts can appear augmented through a user's existing account interface and allow for effortless cancellation augmenting a financial account relationship. This approach potentially reduces the step to authorize financial transaction data into an outside the system for identification and cancellation of undesired accounts. This approach also allows a financial company to add a new user benefit in the way purchase insurance, credit monitoring, and similar perks have nudged users to choose a particular financial company in the past.

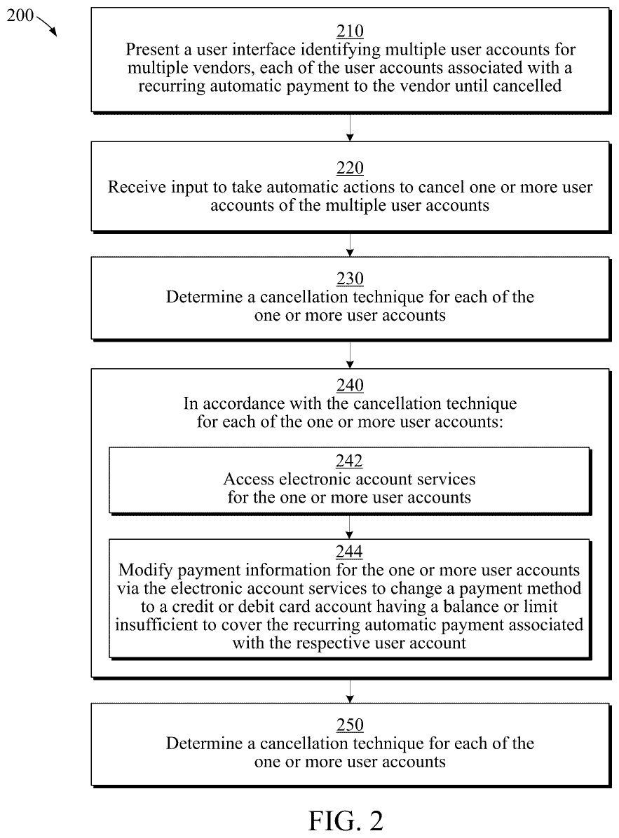

FIG. 2 is a flow chart illustrating an exemplary method 200 for addressing undesired user account subscriptions. In some implementations, the method 200 is performed by a device, such as a mobile device, desktop, laptop, or server device. In some implementations, the method 200 is performed by processing logic, including hardware, firmware, software, or a combination thereof. In some implementations, the method 200 is performed by a processor executing code stored in a non-transitory computer-readable medium (e.g., a memory). Each of the blocks in the method 200 may be enabled and executed in any order.

At block 210, the method 200 involves presenting a user interface identifying multiple user accounts for multiple vendors, each of the user accounts associated with a recurring automatic payment to the vendor until cancelled. The user accounts may be identified via an automatic account identification process, for example, a process that examines a user's checking, credit, or other financial accounts for recurrent payments. Accounts that require contractual changes for cancellation may be flagged. The user may provide login credentials for one or more user accounts of the multiple user accounts or existing sessions may be identified (e.g., by identifying open apps on a mobile device or open webpages corresponding to a respective user account).

At block 220, the method 200 involves receiving input to take automatic actions to cancel one or more user accounts of the multiple user accounts. For example, a user may select a subset or all of the user accounts and initiate a user interface command to initiate automatic cancellation of the accounts.

At block 230, the method 200 involves determining a cancellation technique for each of the one or more user accounts. For example, such a determination may be based on a repository with account vendor-specific info. Such a repository may be maintained (e.g., by a cancellation service provider) by monitoring and tracking landscape of paths to billing info pages on account vendor websites.

At block 240, the method 200 involves, in accordance with the cancellation technique for each of the one or more user accounts: accessing electronic account services for the one or more user accounts (as shown in block 242) and/or modifying payment information for the one or more user accounts via the electronic account services to change a payment method to a credit or debit card account having a balance or limit insufficient to cover the recurring automatic payment associated with the respective user account (as shown in block 244). Accessing the electronic account services, for example, may involve using login credentials to create new webpage/app sessions or accessing an existing session(s) on an already open webpage or app. Modifying the payment information may involve specifying a credit or debit card account with a $0, $1, $2, $5, etc. balance or limit. The method may involve changing contact info associated with the account (e.g., changing user e-mail, phone, etc.). Doing so may enable vendor inquiries to be addressed automatically. A repository of prepaid debit cards, etc. may be maintained for ready use so that cancellation processes may begin immediately upon receiving the user's instruction to cancel the accounts. The user interface may show the user live or recorded the changes made to the accounts as the automatic cancellation processes are performed.

At block 250, the method 200 involves providing a notification via the user interface that the one more user accounts have been modified for cancellation purposes.

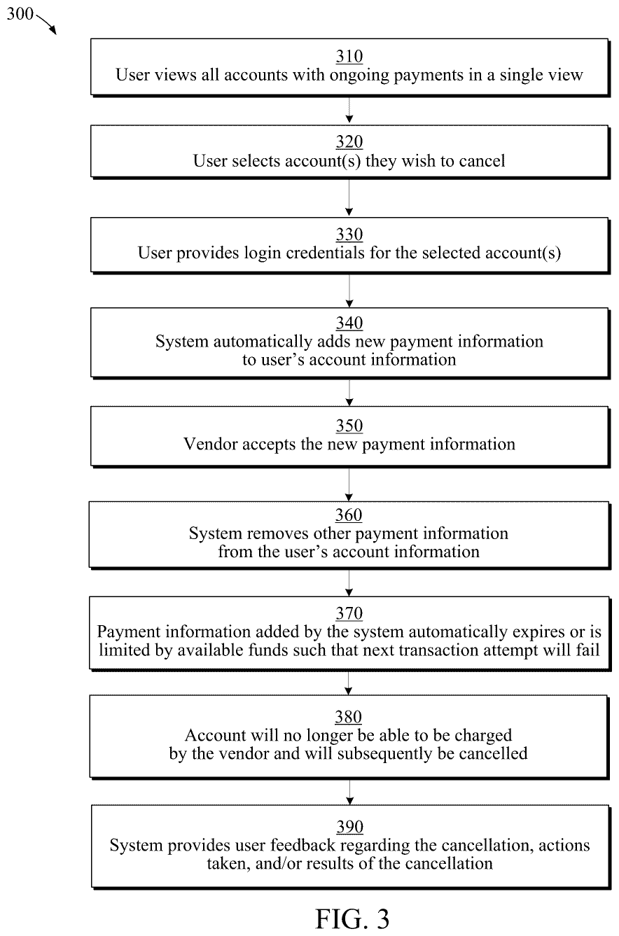

FIGS. 3-10 illustrate exemplary methods for addressing undesired user account subscriptions. Any of these methods 300, 400, 500, 600, 700, 800, 900, 1000 may be performed or facilitated by a device, such as a mobile device, desktop, laptop, or server device. Any of these methods 300, 400, 500, 600, 700, 800, 900, 1000 may be performed by processing logic, including hardware, firmware, software, or a combination thereof. Any of these methods 300, 400, 500, 600, 700, 800, 900, 1000 may be performed by a processor executing code stored in a non-transitory computer-readable medium (e.g., a memory). The blocks in these methods 300, 400, 500, 600, 700, 800, 900, 1000 may be executed in any order.

FIG. 3 is a flow chart illustrating another exemplary method for addressing undesired user account subscriptions. At block 310, the user views all accounts with ongoing payments in a single view. At block 320, the user selects account(s) they wish to cancel. At block 330, the user provides login credentials for the selected account(s). At block 340, the system automatically adds new payment information to the user's account information. At block 350, the vendor accepts the new payment information. At block 360, the system removes other payment information from the user's account information. At block 370, the payment information added by the system automatically expires or is limited by available funds such that the next transaction attempt (by the vendor) will fail. At block 380, the account will no longer be able to be charged by the vendor and will subsequently be cancelled (by the vendor). At block 390, the system provides feedback regarding the cancellation, action taken, and/or results of the cancellation to the user via the user interface, a text message, an e-mail, etc.

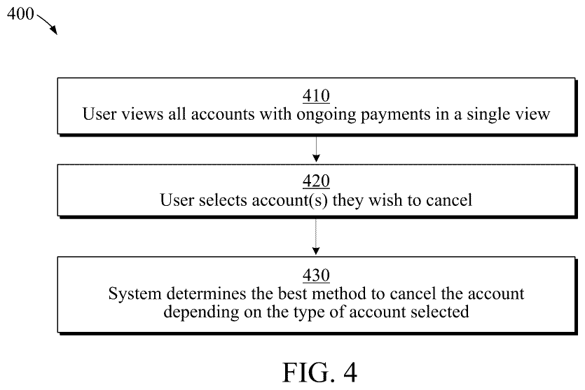

FIG. 4 is a flow chart illustrating another exemplary method for addressing undesired user account subscriptions. At block 410, the user views all accounts with ongoing payments in a single view. At block 420, the user selects account(s) they wish to cancel. At block 430, the system determines the best method to cancel the account depending upon the type of the account selected. For example, the type of the account may determine whether an automatic cancellation process should be used, an automatic process should be used to change payment information, or a guided manual process should be used.

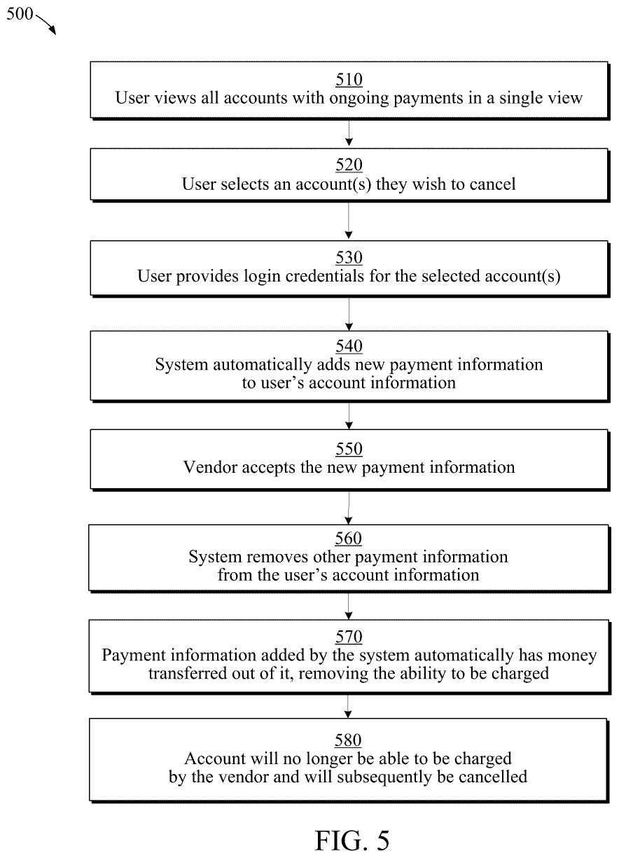

FIG. 5 is a flow chart illustrating another exemplary method for addressing undesired user account subscriptions. At block 510, the user views all accounts with ongoing payments in a single view. At block 520, the user selects account(s) they wish to cancel. At block 530, the user provides login credentials for the selected account(s). At block 540, the system automatically adds new payment information to the user's account information. At block 550, the vendor accepts the new payment information. At block 560, the system removes other payment information from the user's account information. At block 570, the payment information added by the system automatically has money transferred out of it, removing the ability to be charged. At block 580, the account will no longer be able to be charged by the vendor and will subsequently be cancelled (by the vendor). The system may provide feedback regarding the cancellation, action taken, and/or results of the cancellation to the user via the user interface, a text message, an e-mail, etc.

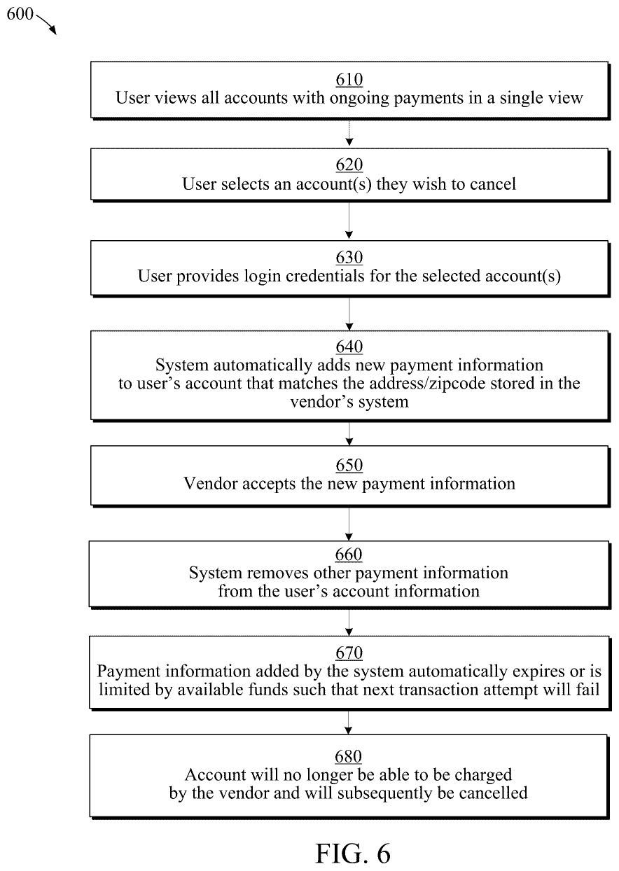

FIG. 6 is a flow chart illustrating another exemplary method for addressing undesired user account subscriptions. At block 610, the user views all accounts with ongoing payments in a single view. At block 620, the user selects account(s) they wish to cancel. At block 630, the user provides login credentials for the selected account(s). At block 640, the system automatically adds new payment information to the user's account that matches the address and/or zip code stored in the vendor's system. At block 650, the vendor accepts the new payment information. At block 660, the system removes other payment information from the user's account information. At block 670, the payment information added by the system automatically expires or is limited by available funds such that the next transaction attempt (by the vendor) will fail. At block 680, the account will no longer be able to be charged by the vendor and will subsequently be cancelled (by the vendor). The system may provide feedback regarding the cancellation, action taken, and/or results of the cancellation to the user via the user interface, a text message, an e-mail, etc.

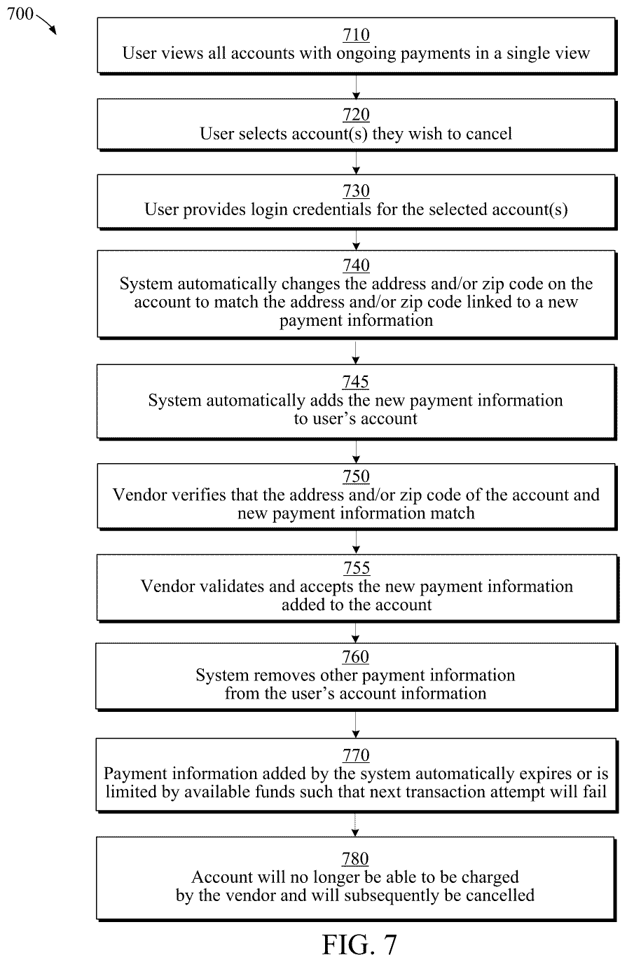

FIG. 7 is a flow chart illustrating another exemplary method for addressing undesired user account subscriptions. At block 710, the user views all accounts with ongoing payments in a single view. At block 720, the user selects account(s) they wish to cancel. At block 730, the user provides login credentials for the selected account(s). At block 740, the system automatically changes the address and/or zip code on the account to match the address and/or zip code linked to a new payment information. At block 745, the system automatically adds the new payment information to the user's account. At block 550, the vendor verifies that the address and/or zip code of the account and the new payment information match. At block 755, the vendor validates and accepts the new payment information added to the account. At block 760, the system removes other payment information from the user's account information. At block 770, the payment information added by the system automatically expires or is limited by available funds such that the next transaction attempt (by the vendor) will fail. At block 780, the account will no longer be able to be charged by the vendor and will subsequently be cancelled (by the vendor). The system may provide feedback regarding the cancellation, action taken, and/or results of the cancellation to the user via the user interface, a text message, an e-mail, etc.

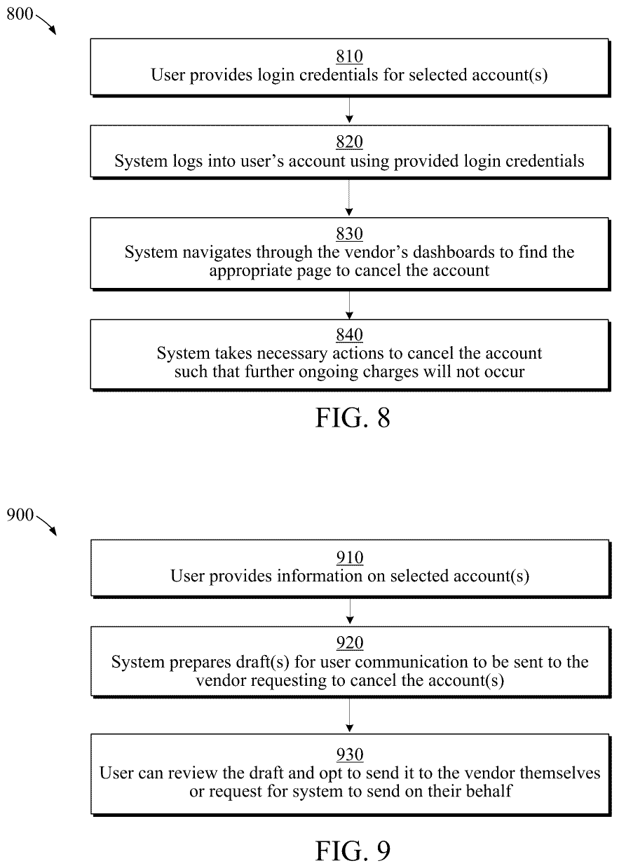

FIG. 8 is a flow chart illustrating another exemplary method for addressing undesired user account subscriptions. At block 810, the user provides login credentials for selected account(s). At block 820, the system logs into the user's account using the provided login credentials. At block 830, the system navigates through the vendor's dashboards to find appropriate page/access point to cancel the account. At block 840, the system takes necessary actions to cancel the account such that further ongoing charges will not occur.

FIG. 9 is a flow chart illustrating another exemplary method for addressing undesired user account subscriptions. At block 910, the user provides information on selected accounts(s), for example, identifying the accounts by identifying the vendor and an account number or identifier. At block 920, the system prepares draft(s) for user communication to be sent to the vendor requesting to cancel the account(s). At block 930, the user can review the draft and opt to send it to the vendor themselves or request for the system to send it on their behalf.

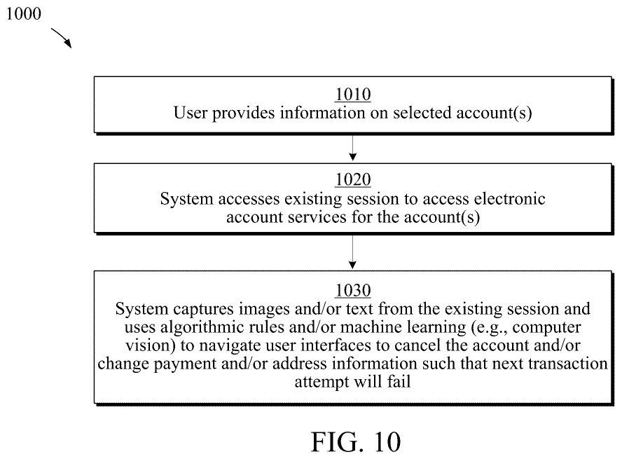

FIG. 10 is a flow chart illustrating another exemplary method for addressing undesired user account subscriptions. At block 1010, the user provides information on selected account(s), for example, identifying the accounts by identifying the vendor and an account number or identifier. At block 1020, the system accesses an existing session(s) to access electronic account services for the account(s). At block 1030, the system captures images and/or text from the existing session and uses algorithmic rules and/or machine learning (e.g., computer vision) to navigate user interfaces to cancel the account and/or change payment and/or address information such that the next transaction attempt will fail.

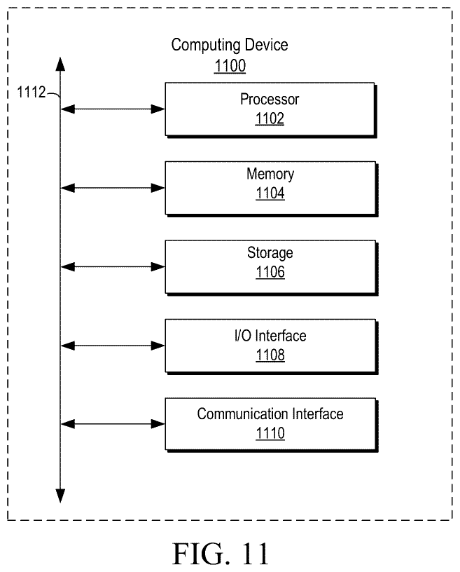

FIG. 11 is a block diagram depicting an example hardware implementation for the devices described in FIG. 1. Each such device 1100 may include a processor 1102 that is communicatively coupled to memory 1104 and storage 1106 and that executes computer-executable program code and/or access information stored in the memory 1104 and storage 1106. The processor 1102 may comprise a microprocessor, an application-specific integrated circuit (“ASIC”), a state machine, or other processing device. The processor 1102 can include any of a number of processing devices, including one. Such a processor 1102 can include or may be in communication with a computer-readable medium storing instructions that, when executed by the processor, cause the processor to perform the operations described herein.

The memory 1104 and storage 1106 can include any suitable computer-readable medium. The computer-readable medium can include any electronic, optical, magnetic, or other storage device capable of providing a processor with computer-readable instructions or other program code. Non-limiting examples of a computer-readable medium include a magnetic disk, memory chip, ROM, RAM, and ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++ C#, Visual Basic, Java, Python, Perl, and JavaScript.

The device 1100 may also comprise a number of external or internal devices such as input or output devices. For example, the device 1100 may have input/output (“I/O”) interface 1108 that can receive input from input devices or provide output to output devices. A bus 1112 can also be included in the device 1100. The bus 1112 can communicatively couple one or more components.

The device 1100 can also include at least one network interface device or other communication interface 1110. The communication interface 1100 can include any device or group of devices suitable for establishing a wired or wireless data or telephone connection to one or more networks. Non-limiting examples of a network interface device include an Ethernet network adapter, a modem, and/or the like. A device can transmit messages as electronic or optical signals.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not be described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more Implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

The foregoing description and summary of the invention are to be understood as being in every respect illustrative and exemplary, but not restrictive, and the scope of the invention disclosed herein is not to be determined only from the detailed description of illustrative Implementations but according to the full breadth permitted by patent laws. It is to be understood that the Implementations shown and described herein are only illustrative of the principles of the present invention and that various modification may be implemented by those skilled in the art without departing from the scope and spirit of the invention.

What is claimed is:

1. A method comprising:
at a processor of an electronic device:
presenting a user interface identifying multiple user accounts for multiple vendors, each of the user accounts associated with a recurring automatic payment to the vendor until cancelled;
receiving input to take automatic actions to cancel one or more user accounts of the multiple user accounts;
determining a cancellation technique for each of the one or more user accounts;
in accordance with the cancellation technique for each of the one or more user accounts:
accessing electronic account services for the one or more user accounts; and
modifying payment information for the one or more user accounts via the electronic account services to change a payment method to a credit or debit card account having a balance or limit insufficient to cover the recurring automatic payment associated with the respective user account; and
providing a notification via the user interface that the one more user accounts have been modified for cancellation purposes.

2. The method of claim 1 further comprising identifying the multiple user accounts via an automated process that inspects a user financial account for recurring payments.

3. The method of claim 1 further comprising identifying the multiple user accounts via a machine learning model that inspects a user financial account for recurring payments.

4. The method of claim 1 further comprising distinguishing user accounts that require contractual changes for cancellation.

5. The method of claim 1 further comprising receiving login credentials for the one or more user accounts, wherein the electronic account services for the one or more user accounts are accessed based on the login credentials.

6. The method of claim 1 further comprising identifying existing sessions accessing the one or more user accounts via an app or webpage, wherein the electronic account services for the one or more user accounts are accessed based on the existing sessions.

7. The method of claim 1, wherein determining the cancellation technique for each of the one or more user accounts is based on a repository storing account vendor-specific information.

8. The method of claim 7 further comprising maintaining the repository by monitoring and tracking navigation paths to billing information access points at user interfaces of the electronic account services for the one or more user accounts.

9. The method of claim 1, wherein modifying the payment information for the one or more user accounts comprises specifying a debit card having a balance below a predetermined threshold.

10. The method of claim 1, wherein modifying the payment information for the one or more user accounts comprises specifying a payment card having a limit below a predetermined threshold.

11. The method of claim 1 further comprising changing an e-mail address or phone number for the one or more user accounts to a number associated with an automatic response service to enable vendor inquiries to be addressed automatically.

12. The method of claim 1 further comprising maintaining a repository of prepaid debit cards having a balance below a predetermined limit for use in modifying the payment information.

13. The method of claim 1 further comprising providing a live view of automatic actions taken via user interfaces of the electronic account services.

14. The method of claim 1 further comprising recording video showing the automatic actions taken via user interfaces of the electronic account services.

15. The method of claim 1 further comprising determining navigation pathways to account information change points via user interfaces of the electronic account services using a machine learning process that analyzes screen images during automatic actions taken via the user interfaces of the electronic account services.

16. The method of claim 1 further comprising determining navigation pathways to account information change points via user interfaces of the electronic account services using a machine learning process that analyzes textual user interface information obtained during automatic actions taken via the user interfaces of the electronic account services.

17. The method of claim 1 further comprising:
monitoring webpages or apps providing the interfaces of the electronic account services for changes; and
automatically updating automatic action scripts based on the changes.

18. The method of claim 1 further comprising automatically drafting correspondence to the electronic account services for a user to review and send to the electronic account services.

19. An electronic device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
presenting a user interface identifying multiple user accounts for multiple vendors, each of the user accounts associated with a recurring automatic payment to the vendor until cancelled;
receiving input to take automatic actions to cancel one or more user accounts of the multiple user accounts;
determining a cancellation technique for each of the one or more user accounts;
in accordance with the cancellation technique for each of the one or more user accounts:
accessing electronic account services for the one or more user accounts; and
modifying payment information for the one or more user accounts via the electronic account services to change a payment method to a credit or debit card account having a balance or limit insufficient to cover the recurring automatic payment associated with the respective user account; and
providing a notification via the user interface that the one more user accounts have been modified for cancellation purposes.

20. A non-transitory computer-readable storage medium, storing program instructions computer-executable on a computer to perform operations comprising:
presenting a user interface identifying multiple user accounts for multiple vendors, each of the user accounts associated with a recurring automatic payment to the vendor until cancelled;
receiving input to take automatic actions to cancel one or more user accounts of the multiple user accounts;
determining a cancellation technique for each of the one or more user accounts;
in accordance with the cancellation technique for each of the one or more user accounts:
accessing electronic account services for the one or more user accounts; and
modifying payment information for the one or more user accounts via the electronic account services to change a payment method to a credit or debit card account having a balance or limit insufficient to cover the recurring automatic payment associated with the respective user account; and
providing a notification via the user interface that the one more user accounts have been modified for cancellation purposes.
